(19) United States
(12) Patent Application Publication
(10) Pub. No.: US 2017/0083352 A1
(43) Pub. Date: Mar. 23, 2017

(54) SENSOR HUB, COMMUNICATIONS APPARATUS AND METHOD FOR PERSONALIZED MODEL TRAINING

(71) Applicant: MediaTek Inc., Hsin-Chu (TW)

(72) Inventors: Tsung-Yu CHIOU, Hsinchu County (TW); Chih-Hsiang HSIAO, Taipei City (TW); Po-Yu CHEN, Zhubei City (TW)

(21) Appl. No.: 15/263,409

(22) Filed: Sep. 13, 2016

Related U.S. Application Data
(60) Provisional application No. 62/220,362, filed on Sep. 18, 2015.

(51) Int. Cl. G06F 9/445; G06N 99/00

(52) U.S. Cl. CPC G06F 9/44505; G06N 99/005

(57) ABSTRACT

A sensor hub coupled to one or more sensors and an application processor of a communications apparatus includes a sensing module and a micro-processor. The sensing module receives raw data from the sensors. The raw data is generated by the sensors when sensing one or more events. The micro-processor constructs an adaptive model according to a plurality of parameters and identifies user activity according to the raw data based on the adaptive model. The sensor hub is an always-on sub-system for assisting the application processor to identify user activity according to the raw data. The micro-processor further receives updated parameters and updates the adaptive model according to the updated parameters.

### CROSS REFERENCE TO RELATED APPLICATIONS

This application claims the benefit of U.S. Provisional Application No. 62/220,362 filed Sep. 18, 2015 and entitled “Method and an Apparatus for Personalized Model Learning”, the entire contents of which are hereby incorporated by reference.

### BACKGROUND OF THE INVENTION

Field of the Invention

The invention relates to a sensor hub and methods for personalized model training.

Description of the Related Art

Mobile devices have become an important part of our lives. People often carry mobile devices wherever they go and customize devices according to their personal preferences, environment, and/or habits. Modern mobile devices typically include various types of sensors and other data input components. These sensors gather data about the environment surrounding the mobile device and/or the user of the mobile device, and may provide information regarding device location, motion, and/or other activities. A user may also utilize a mobile device in connection with a variety of applications. Monitoring such interactions may provide additional information regarding a user's activities.

Information regarding a mobile device user's activities may be utilized in a variety of contexts. For example, advertisement-based content distribution systems may be utilized to help fund the production of content, the services that distribute the content, and the devices that render the content. To maximize the benefit of ad-based content distribution systems, advertisements delivered to a consumer should ideally be well-matched to the interests of the consumer at a time and/or location at which the consumer is likely to purchase advertised goods and/or services. Similarly, services that distribute offers, promotions, or other services seek to target the distribution of such materials to those individuals most likely to be interested.

Since identifying user activities benefits the development of a variety of different fields of application, it is desirable to improve identification accuracy.

### BRIEF SUMMARY OF THE INVENTION

A sensor hub, a communications apparatus and a method for personalized model training are provided. An exemplary embodiment of a sensor hub coupled to one or more sensors and an application processor of a communications apparatus comprises a sensing module and a micro-processor. The sensing module receives raw data from the sensors. The raw data is generated by the sensors when sensing one or more events. The micro-processor executes an adaptive model according to a plurality of parameters and identifies user activity according to the raw data based on the adaptive model. The sensor hub is an always-on sub-system for assisting the application processor to identify user activity according to the raw data. The micro-processor further receives updated parameters and updates the adaptive model according to the updated parameters.

An exemplary embodiment of a communications apparatus comprises an application processor and a sensor hub. The application processor runs an operating system of the communications apparatus. The sensor hub is coupled to one or more sensors and the application processor, and receives raw data from the sensors. The sensor hub comprises a micro-processor executing an adaptive model according to a plurality of parameters and identifying user activity according to the raw data based on the adaptive model. The sensor hub is an always-on sub-system for assisting the application processor to identify user activity according to the raw data. The micro-processor further receives updated parameters and updates the adaptive model according to the updated parameters.

An exemplary embodiment of a method for personalized model training comprises: utilizing a sensor hub of a communications apparatus to collect raw data from a sensor, wherein the raw data is generated by the sensor when sensing one or more events; labeling the raw data according to user activity to generate the labeled data, wherein the labeled data comprises information describing corresponding user activity of the raw data; providing the labeled data to a training platform for performing model training based on the labeled data, wherein the adaptive model is executed by a micro-processor of the sensor hub; receiving updated parameters of an adaptive model that has been trained based on the labeled data and updating the adaptive model according to the updated parameters.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows an exemplary block diagram of a communications apparatus according to an embodiment of the invention;

FIG. 2 shows an exemplary block diagram of a modem according to an embodiment of the invention;

FIG. 3 shows an exemplary block diagram of a sensor hub according to an embodiment of the invention;

FIG. 4A is a diagram showing conventional user activity identification procedure;

FIG. 4B is a diagram showing the proposed user activity identification procedure according to an embodiment of the invention;

FIG. 5 is a schematic diagram showing architecture for personalized model learning according to an embodiment of the invention;

FIG. 6 is a schematic diagram showing architecture for personalized model learning according to another embodiment of the invention; and

FIG. 7 is a flow chart showing a method for personalized model training according to an embodiment of the invention.

### DETAILED DESCRIPTION OF THE INVENTION

The following description is of the best-contemplated mode of carrying out be invention. This description is made for the purpose of illustrating the general principles of the invention and should not be taken in a limiting sense. The scope of the invention is best determined by reference to the appended claims.

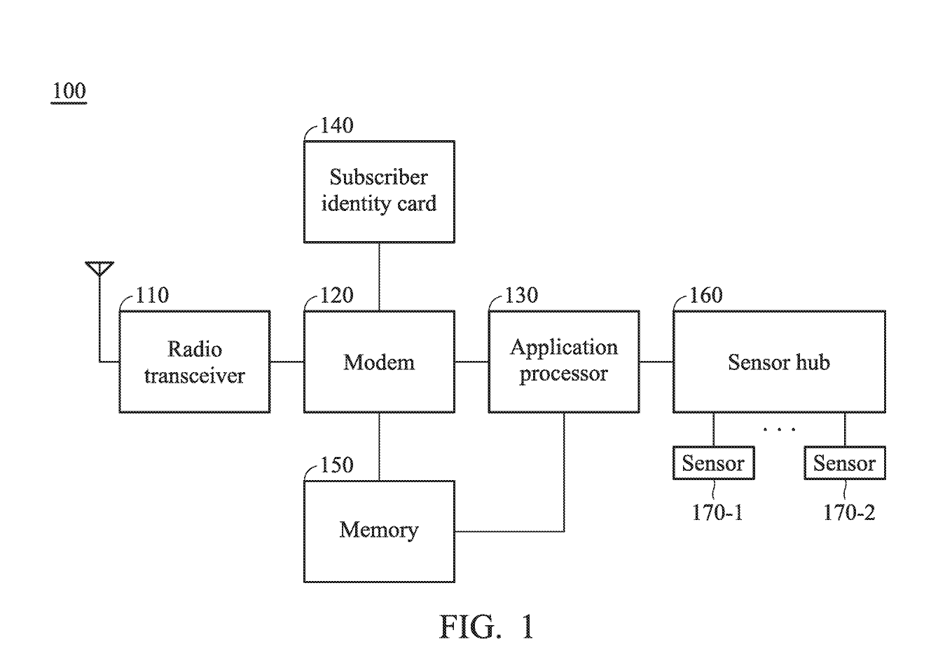

FIG. 1 shows an exemplary block diagram of a communications apparatus according to an embodiment of the invention. The communications apparatus 100 may be a portable electronic device, such as a Mobile Station (MS, which may be interchangeably referred to as User Equipment (UE)). The communications apparatus 100 may comprise at least some of at least an antenna module comprising at least one antenna, a radio transceiver 110, a modem 120, an application processor 130, a subscriber identity card 140, a memory 150, a sensor hub 160 and a plurality of sensors 170-1, . . . 170-n, where n is a positive integer. The radio transceiver 110 may receive wireless radio frequency signals via the antenna module, transmit wireless radio frequency signals via the antenna module, and perform RF signal processing. For example, the radio transceiver 110 may convert the received signals to intermediate frequency (IF) or baseband signals to be processed, or receive the IF or baseband signals from the modem 120 and convert the received signals to wireless radio frequency signals to be transmitted to a network device. According to an embodiment of the invention, the network device may be a cell, an evolved node B, a base station, a Mobility Management Entity (MME) etc., at the network side and may communicate with the communications apparatus 100 via the wireless radio frequency signals.

The radio transceiver 110 may comprise a plurality of hardware devices to perform radio frequency conversion and RF signal processing. For example, the radio transceiver 110 may be circuitry and may comprise a power amplifier circuit for amplifying the RF signals, a filter circuit for filtering unwanted portions of the RF signals, a frequency synthesizer circuit for generating a signal oscillating at a desired radio frequency and or a mixer circuit for performing radio frequency conversion. According to an embodiment of the invention, the radio frequency may be, for example, 900 MHz or 1800 MHz for a Global System for Mobile communication (GSM), or 1900 MHz for a Universal Mobile Telecommunications System (UNITS), or the frequency of any specific frequency band for a Long-Term Evolution (LTE) system, etc.

The modem 120 may be a cellular communications modem configured for handling cellular system communications protocol operations and processing the IF or baseband signals received from, or to be transmitted to, the radio transceiver 110. The application processor 130 is configured for running the operating system of an application framework of the communications apparatus 100 and running application programs installed in the communications apparatus 100. In the embodiments of the invention, the modem 120 and the application processor 130 may be designed as discrete chips with some buses or hardware interfaces coupled therebetween, or they may be integrated into a combo chip (i.e., a system on chip (SoC)), and the invention should not be limited thereto.

The subscriber identity card 140 may be a SIM, USIM, R-UIM or CSIM card, or the like and may typically contain user account information, an International Mobile Subscriber Identity (IMSI) and or a set of SIM application toolkit (SAT) commands, and it may provide storage space for phone book contacts. The memory 150 may be coupled to the modem 120 and application processor 130 and may store system data or user data.

The sensor hub 160 is an always-on sub-system (that is, once the sub-system is activated, the sub-system keeps operating in a stand-by mode and running the corresponding programs to provide corresponding functions) with low power consumption. The sensor hub 160 may act as an assistant sub-system of the application processor 130 for handling real-time and/or relatively simple or low computation tasks compared to the relatively complicated or high computation tasks that are handled by the application processor 130. Note that in the embodiments, the sensor hub 160 and application processor 130 can operate independently.

The sensor hub 160 may be coupled to one or more sensors 170-1, . . . 170-n. The sensors 170-1, 170-n may, for example, be a touch sensor, a GPS receiver, a gyroscope sensor, an accelerator, a Bluetooth transceiver, a WiFi transceiver or any other type of sensor, and be configured to sense the corresponding data and provide the sensed data to the sensor hub 160, but the invention should not be limited to the examples listed above.

Note that, in order to clarify the concept of the invention, FIG. 1 presents a simplified block diagram in which only the elements relevant to the invention are shown. For example, in some embodiments of the invention, the communications apparatus may further comprise some peripheral devices not shown in FIG. 1. In another example, in some embodiments of the invention, the communications apparatus may further comprise a central controller coupled to the modem 120 and the application processor 130. Therefore, the invention should not be limited to what is shown in FIG. 1.

Note further that although FIG. 1 shows a single-card single-standby application, the invention should not be limited thereto. For example, in some embodiments of the invention, the communications apparatus may comprise multiple subscriber identity cards to support multiple radio access technologies (RATs) communications. In the multiple RATs communications applications, the modem, the radio transceiver and/or the antenna module may be shared by the subscriber identity cards and may have the capability of handling the operations of multiple cellular system communications protocols and processing the corresponding RF, IF or baseband signals in compliance with multiple cellular system communications protocols. Those who are skilled in this technology can still make various alterations and modifications based on the descriptions given above to derive the communications apparatuses comprising multiple radio transceivers and/or multiple antenna modules for supporting multiple RAT wireless communications without departing from the scope and spirit of this invention. Therefore, in some embodiments of the invention, the communications apparatus may be designed to support a multi-card multi-standby application by making some alterations and modifications.

Note further that the subscriber identity card 140 may be dedicated hardware cards as described above, or in some embodiments of the invention, there may be individual identifiers, numbers, addresses, or the like which are burned in the internal memory of the corresponding modem and are capable of identifying the communications apparatus. Therefore, the invention should not be limited to what is shown in the figures.

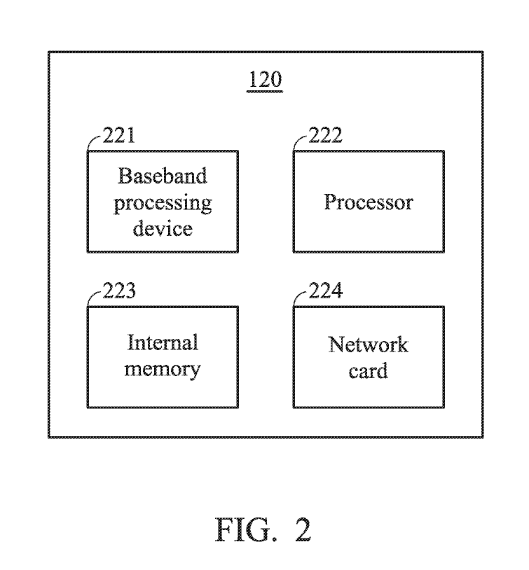

FIG. 2 shows an exemplary block diagram of a modem according to an embodiment of the invention. The modem 120 may comprise at least a baseband processing device 221, a processor 222, an internal memory 223 and a network card 224. The baseband processing device 221 may receive the IF or baseband signals from the radio transceiver 110 and perform IF or baseband signal processing. For example, the baseband processing device 221 may convert the IF or baseband signals to a plurality of digital signals, and process the digital signals, and vice versa. The baseband processing device 221 may be circuitry and may comprise a plurality of circuits to perform signal processing, such as an analog-to-digital converter circuit for ADC conversion, a digital-to-analog converter circuit for DAC conversion, an amplifier circuit for gain adjustment, a modulator circuit for signal modulation, a demodulator circuit for signal demodulation, a encoder circuit for signal encoding, a decoder circuit for signal decoding, and so on.

The processor may control the operations of the modem 120. According to an embodiment of the invention, the processor 222 may be configured to execute the program codes of the corresponding software module of the modem 120. The processor may maintain and execute the individual tasks, threads, and/or protocol stacks for different software modules. In a preferred embodiment, a protocol stack may be implemented so as to respectively handle the radio activities of one RAT. However, it is also possible to implement more than one protocol stack to handle the radio activities of one RAT at the same time, or implement only one protocol stack to handle the radio activities of more than one RAT at the same time, and the invention should not be limited thereto.

The processor 222 may also read data from the subscriber identity card coupled to the modem, such as the subscriber identity card 140, and write data to the subscriber identity card. The internal memory 223 may store system data and user data for the modem 120. The processor 222 may also access the internal memory 223.

The network card 224 provides Internet access services for the communications apparatus. Note that although the network card 224 shown in FIG. 2 is configured inside of the modem, the invention should not be limited thereto. In some embodiments of the invention, the communications apparatus may also comprise a network card configured outside of the modem, or the communications apparatus may also be coupled to an external network card for providing Internet access services. Therefore, the invention should not be limited to any specific implementation method.

Note further that in order to clarify the concept of the invention, FIG. 2 presents simplified block diagrams in which only the elements relevant to the invention are shown. Therefore, the invention should not be limited to what is shown in FIG. 2.

Note further that in some embodiments of the invention, the modem may comprise more than one processor and/or more than one baseband processing device. For example, the modem may comprise multiple processors and/or multiple baseband processing devices for supporting multi-RAT operations. Therefore, the invention should not be limited to what is shown in FIG. 2.

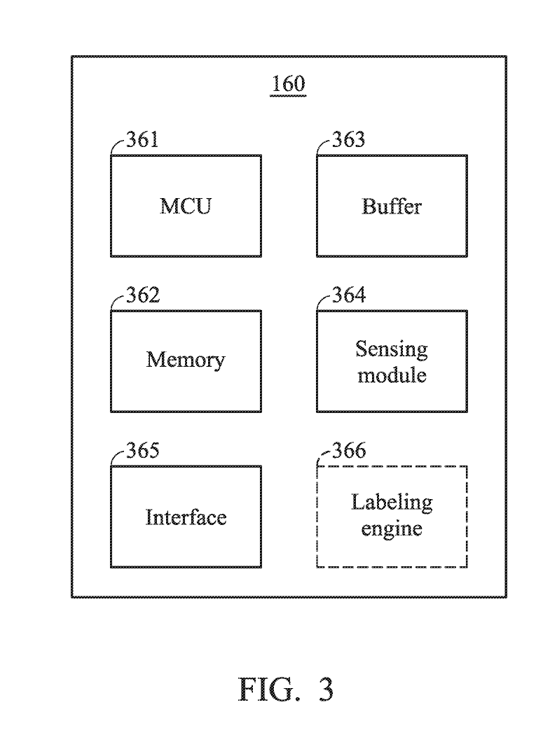

FIG. 3 shows an exemplary block diagram of a sensor huh according to an embodiment of the invention. The sensor hub 160 may comprise at least a micro-processor (MCU) 361, an internal memory 362, a buffer 363, a sensing module 364 and an interface 365. The MCU 361 may control the operations of the sensor hub 160. According to an embodiment of the invention, the MCU 361 may be configured to execute the program codes of the corresponding software module of the sensor hub 160. As illustrated above, the sensor hub 160 is an always-on sub-system with low power consumption for handling real-time and/or relatively simple or low-computation tasks compared to the relatively complicated or high-computation tasks that are handled by the application processor 130.

The sensing module 364, which may be implemented by either a dedicated hardware circuit, software programs that are executed by the MCU 361 or a combination thereof, may receive and collect raw data from the sensors. The raw data is generated by the sensors when sensing one or more events. The buffer 363 may buffer the raw data received from the sensing module 364 and output the raw data to the application processor 130 in a first-in first-out (FIFO) manner via the interface 365. The interface 365 may comprise one or more buses coupled to the application processor 130 and/or the sensors. The internal memory 362 may store sub-system data and also raw data.

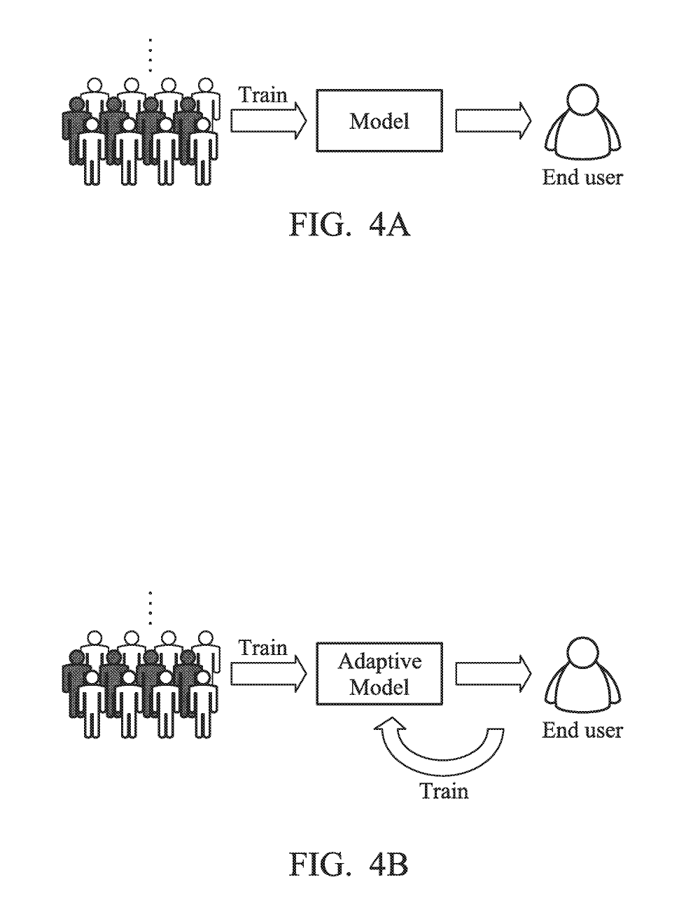

FIG. 4A is a diagram showing conventional user activity identification procedure. Conventionally, a trained model is pre-loaded in the memory of an electronic device when, for example the electronic device is manufactured. The model may be a function, an algorithm, a software program, or the like, and it may be trained based on the user data collected from a predetermined group of users. However, the predetermined group of users usually does not include the end user using the electronic device, and the model pre-loaded in the electronic device will not be updated. Therefore, the model may be not suitable for the end user and the identification result may be inaccurate, especially when the end user behaves quite differently from the predetermined group of users.

To solve this problem, methods for providing an adaptive model that can be adaptively trained based on the data with end user's information are provided.

FIG. 4B is a diagram showing the proposed user activity identification procedure according to an embodiment of the invention. According to the embodiment of the invention, the communications apparatus may collect the end user's data and provide the end user's data for model training. The model that was originally trained based on the user data collected from the predetermined group of users can be adaptively trained further based on the end user's data, and the model stored in the communications apparatus is configurable and can be updated according to the information regarding the newly trained model (for example, the updated parameters or updated software programs of the trained model). In this manner, the model can become more suitable for the end user and the identification accuracy can be improved.

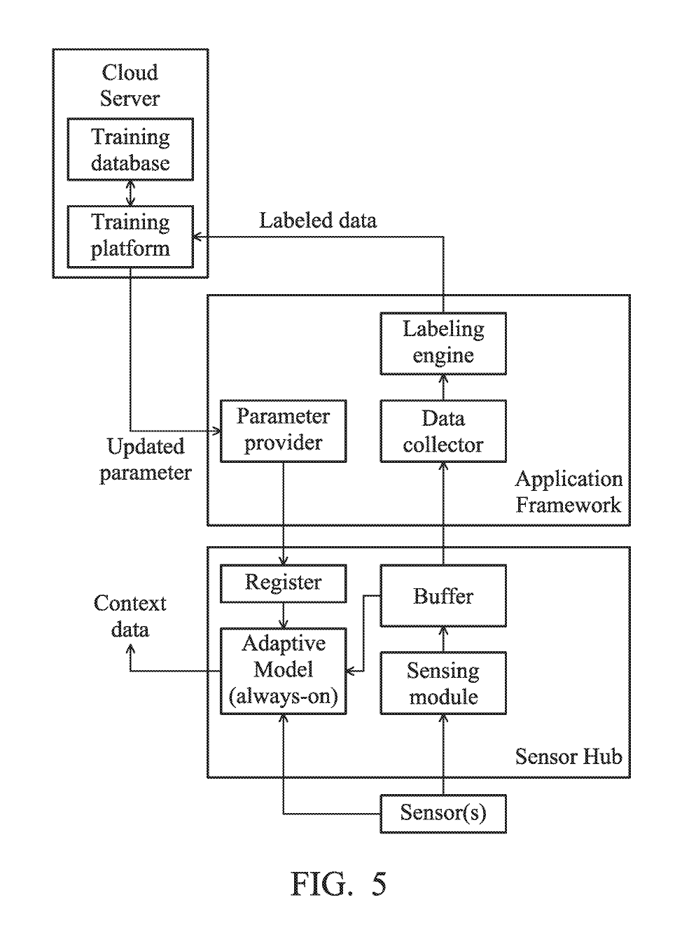

FIG. 5 is a schematic diagram showing architecture for personalized model learning according to an embodiment of the invention. The architecture may comprise a cloud-based model training platform an application framework, and an adaptive sensor hub.

According to an embodiment of the invention, the adaptive sensor hub may be maintained by the sensor hub 160 for ultra-low power activity detection/recognition. Algorithms for the activity detection/recognition, including the gesture detection/recognition, and pedometer detection/recognition . . . etc., on the sensor hub can be programmed using trained parameters.

According to an embodiment of the invention, the sensing module of the sensor hub receives the raw data from the sensors. The raw data is generated by a sensor upon sensing one or more events. The buffer of the sensor hub may buffer the raw data received from the sensing module and output the raw data to the application framework in a FIFO manner.

The raw data is further provided to the adaptive model for identifying the user's activity. According to the embodiment of the invention, the adaptive model is constructed, executed or provided by the MCU 361 according to a plurality of parameters and is configurable. As described above, the model may be a function, an algorithm, a software programs, or the like. When the raw data is input to the adaptive model, the MCU 361 may perform the corresponding computation or execute the corresponding software program codes according to the raw data to identify user activity based on the adaptive model, and obtain an identification result. The identification result may be presented by a probability to describe the most possible activity linking to the input raw data The sensor hub may also output context data describing the identified user activity according to the identification result.

As discussed above, the sensor hub is an always-on sub-system with low power consumption for assisting the application processor to identify user activity according to the raw data. Therefore, in the embodiments of the invention, the sensor hub may perform always-on data sensing.

According to an embodiment of the invention, the application framework may be maintained by the application processor 130 and may be an interface between the cloud-based model training platform and the adaptive sensor hub.

The application framework may comprise a data collector, which may be implemented by a dedicated hardware circuit, software programs or a combination thereof, receiving the raw data from the buffer of the sensor hub and collecting the raw data. The application framework may further comprise a labeling engine. Which may be implemented by a dedicated hardware circuit, software programs or a combination thereof, labeling the raw data to generate the labeled data and providing the labeled data to a cloud server. Compared to the raw data, the labeled data comprises at least addition information describing the corresponding user activity of the raw data. In this manner, the cloud server can identify the pattern of the raw data corresponding to a specific user activity. Note that when the data collector and the labeling engine are implemented by the software programs, the application processor 130 may execute the software programs to implement the corresponding functions.

According to an embodiment of the invention, there may be a variety of ways to perform data labeling. In an embodiment, the application processor 130 may trigger an application to provide an user interface for the user identify their activities (including the gestures, steps, speeds, distance, type of motions, or others), so as to label the corresponding activities on the context data or raw data. The application processor 130 may provide the labeled data, the context data and/or the original raw data to the cloud-based model training platform. In another embodiment, the application processor 130 may also gather and use the raw data generated by other sensors to assist in data labeling. For example, the application processor 130 may use the raw data generated by a GPS receiver to assist the data labeling of the raw data generated by a pedometer. To be more specific, the application processor 130 may use the GPS data to label the corresponding steps, speeds or distance on the context data or on the original raw data generated by a pedometer. The application processor 130 may then provide the labeled data, the context data and/or the original raw data to the cloud-based model training platform.

The cloud-based model training platform may be maintained by the cloud server. The labeled data may be added into the training database and provided to a training platform for training the model. After the training is completed, the cloud server may further provide information regarding the e newly trained model (for example, the updated parameters or updated software programs of the newly trained model) to a parameter provider in the application framework.

The parameter provider may be implemented by a dedicated hardware circuit, software programs or a combination thereof and may receive the information regarding the newly trained model, such as the updated parameters or updated software programs of the newly trained model, and may provide the information regarding the newly trained model to a register of the sensor hub. When the parameter provider is implemented by the software programs, the application processor 130 may execute the software programs to implement the function.

The MCU 361 of the sensor hub may further access the register to receive the information regarding the newly trained model and update the adaptive model according to the received information. Since the information regarding the newly trained model is received from the cloud server over the air, it is also called a model updated over the air.

Based on the architecture shown in FIG. 5, the data of the end user of the communications apparatus 100 can be updated into the training database so that the model can be trained according to the end user's individual characteristics. Therefore, personalized model learning/training can be achieved, and the identification accuracy can be improved.

Note that in some other embodiments of the invention, the model training platform and the training database may also be implemented on the application framework or the sensor hub of the communications apparatus 100, and thus the invention should not be limited to any specific implementation method.

Note further that the labeling engine and the data collector of the application framework may work in the foreground or background. For example, the labeling engine and the data collector may keep collecting the raw data and labeling the raw data in the background and the end user may not be are of that. Therefore, the application processor 130 may be an off-line task runner.

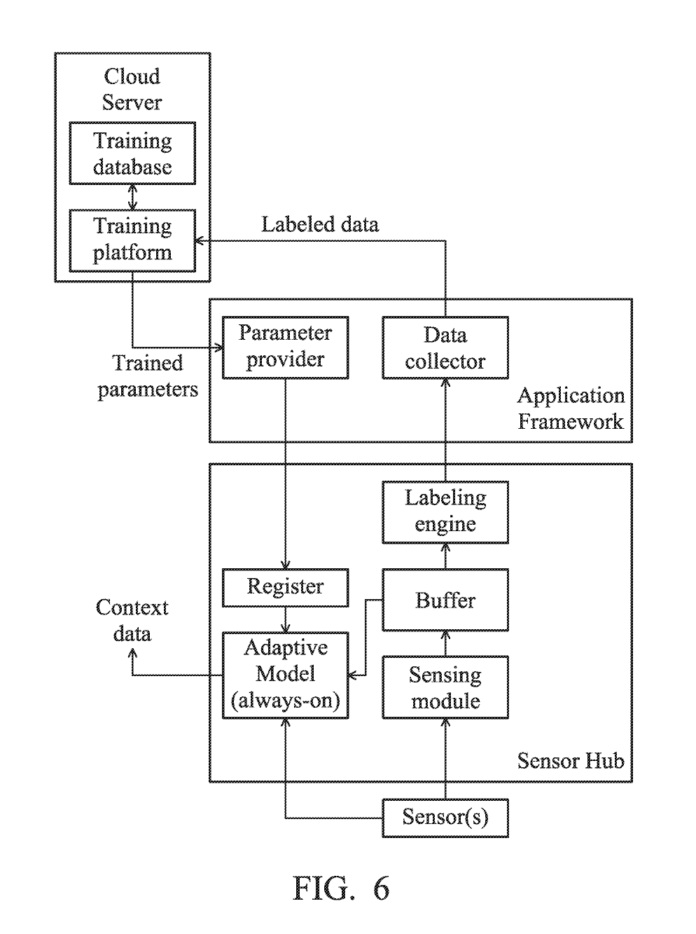

FIG. 6 is a schematic diagram showing architecture for personalized model learning according to another embodiment of the invention. Most of the elements shown in FIG. 6 are similar to those shown in FIG. 5, and the descriptions are omitted here for brevity.

In this embodiment, the sensor hub may further comprise a labeling engine (such as the labeling engine 366 showing in FIG. 3), which may be implemented by a dedicated hardware circuit, software programs or a combination thereof. When the labeling engine is implemented by the software programs, the MCU 361 may execute the software programs to implement the data labeling function.

The labeling engine may collect the raw data from the buffer, label the raw data to generate the labeled data and provide the labeled data to the application framework. Compared to the raw data, the labeled data comprises addition information describing the corresponding user activity of the raw data. In this manner, the cloud server can identify the pattern of the raw data corresponding to a specific user activity.

As described above, there may be a variety of ways to perform data labeling. In an embodiment, the MCU 361 may trigger an application to provide an user interface for the user to identify their activities (including gestures, steps, speed, distance, type of motion, or others), so as to label the corresponding activities on the context data or raw data. In another embodiment, the MCU 361 may also gather and use the raw data generated by other sensors to assist in data labeling. For example, the MCU 361 may use the raw data generated by a GPS receiver to assist the data labeling of the raw data generated by a pedometer.

The data collector in the application framework receives the labeled data from the sensor hub and provides the labeled data to the cloud-based model training platform.

Based on the architecture shown in FIG. 6, the data of the end user of the communications apparatus 100 can be updated into the training database so that the model can be trained according to the end user's individual characteristics. Therefore, personalized model learning/training can be achieved, and the identification accuracy can be improved.

Note that in some other embodiments of the invention, the model training platform and the training database may also be implemented on the application framework or the sensor hub of the communications apparatus 100, and thus the invention should not be limited to any specific implementation method.

Note further that the labeling engine of the sensor hub and the data collector of the application framework may work in the foreground or background. For example, the labeling engine and the data collector may keep working in the background and the end user may not be aware of that.

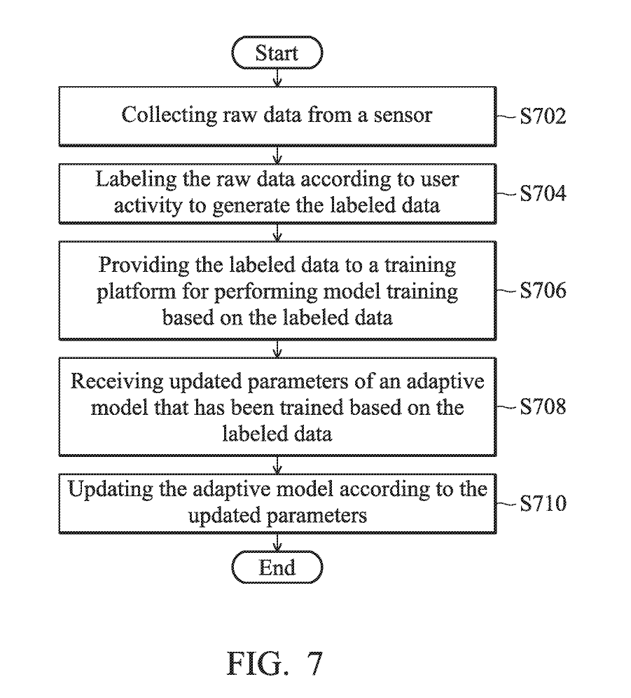

FIG. 7 is a flow chart showing a method for personalized model training according to an embodiment of the invention. First of all, raw data generated by a sensor when sensing one or more events is collected (Step S702). Next, the raw data is labeled according to user activity to generate the labeled data (Step S704). Next, the labeled data is provided to a training platform for performing model training based on the labeled data (Step S706). Next, updated parameters of an adaptive model that has been trained based on the labeled data are received from the training platform (Step S708) and the adaptive model is updated according to the updated parameters (Step S710).

As discussed above, in the embodiments of the invention, the adaptive model is updated by the sensor hub, which is an always-on sub-system with low power consumption. Therefore, low power-consumption and always-on data sensing can be achieved. In addition, in the embodiments of the invention, the model training may be performed by the cloud server, the application processor or the MCU of the sensor hub. Therefore, hardware acceleration can be achieved. In addition, in the embodiments of the invention, the data labeling may be performed by the application processor or the MCU of the sensor hub. The labeled data is further provided for training the model. There, the model can be trained based on personalized information of the end user.

In addition, in the embodiments of the invention, the model can be simply updated by just modifying the parameters describing the model. Since only the updated parameters have to be received, the amount of data that has to be processed is small and the model update procedure is simple and can be finished quickly. In addition, in the embodiments of the invention, since the model is constructed, executed or provided by the sensor hub, there is no need to modify the application framework when updating the model.

The embodiments of the present invention can be implemented in any of numerous ways. For example, the embodiments may be implemented using hardware, software or a combination thereof. It should be appreciated that any component or collection of components that perform the functions described above can be generically considered as one or more processors that control the function discussed above. The one or more processors can be implemented in numerous ways, such as with dedicated hardware, or with general-purpose hardware that is programmed using microcode or software to perform the functions recited above.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims their equivalents.

What is claimed is:

1. A sensor hub, coupled to one or more sensors and an application processor of a communications apparatus, comprising:
a sensing module, receiving raw data from the sensors, wherein the raw data is generated by the sensors when sensing one or more events; and
a micro-processor, executing an adaptive model according to a plurality of parameters and identifying user activity according to the raw data based on the adaptive model,
wherein the sensor hub is an always-on sub-system for assisting the application processor to identify user activity according to the raw data, and
wherein the micro-processor further receives updated parameters and updates the adaptive model according to the updated parameters.

2. The sensor hub as claimed in claim 1, wherein the updated parameters have been trained by a server based on a plurality of data comprising labeled data corresponding to a user of the communications apparatus.

3. The sensor hub as claimed in claim 2, wherein the micro-processor further labels the raw data to generate the labeled data.

4. A communications apparatus, comprising:
an application processor, running an operating system of the communications apparatus; and
a sensor hub, coupled to one or more sensors and the application processor, and receiving raw data from the sensors,
wherein the sensor hub comprises:
a micro-processor, executing an adaptive model according to a plurality of parameters and identifying user activity according to the raw data based on the adaptive model,
wherein the sensor hub is an always-on sub-system for assisting the application processor to identify user activity according to the raw data, and
wherein the micro-processor further receives updated parameters and updates the adaptive model according to the updated parameters.

5. The communications apparatus as claimed in claim 4, wherein the updated parameters have been trained by a server based on a plurality of data comprising labeled data corresponding to a user of the communications apparatus.

6. The communications apparatus as claimed in claim 5, wherein the application processor further receives and collects the raw data from the sensor hub, labels the raw data to generate the labeled data and provides the labeled data to the server.

7. The communications apparatus as claimed in claim 5, wherein the micro-processor further collects and labels the raw data to generate the labeled data.

8. The communications apparatus as claimed in claim 7, wherein the micro-processor further provides the labeled data to the application processor, and the application processor further provides the labeled data to the server.

9. A method for personalized model training, comprising:
utilizing a sensor hub of a communications apparatus to collect raw data from a sensor, wherein the raw data is generated by the sensor when sensing one or more events:
labeling the raw data according to user activity to generate the labeled data, wherein the labeled data comprises information describing corresponding user activity of the raw data;
providing the labeled data to a training platform for performing model training based on the labeled data;
receiving updated parameters of an adaptive model that has been trained based on the labeled data, wherein the adaptive model is executed by a micro-processor of the sensor hub; and
updating the adaptive model according to the updated parameters.

10. The method as claimed in claim 9, wherein the adaptive model is and updated by the micro-processor of a sensor hub,

11. The method as claimed in claim 9, wherein the model training is performed by a server, an application processor of the communications apparatus or the micro-processor.

12. The method as claimed in claim 9, wherein the labeling step is performed by the micro-processor of the sensor hub.

13. The method as claimed in claim 9, wherein the labeling step is performed by an application processor of the communications apparatus.

14. The method as claimed in claim 9, wherein the sensor hub is an always-on sub-system for assisting an application processor of the communications apparatus to identify user activity according to the raw data.
